(19) United States
(12) Patent Application Publication
(10) Pub. No.: US 2014/0325327 A1
(43) Pub. Date: Oct. 30, 2014

(54) REPLACING PROBLEM WEB LINKS USING CONTEXT INFORMATION

(71) Applicant: INTERNATIONAL BUSINESS MACHINES CORPORATION, Armonk, NY (US)

(72) Inventors: Marcus L. Belvin, Wake Forest, NC (US); Matthew C. Hillary, Tyler, TX (US); Benjamin I. Rubinger, Cambridge, MA (US)

(73) Assignee: International Business Machines Corporation, Armonk, NY (US)

(21) Appl. No.: 13/872,393

(22) Filed: Apr. 29, 2013

(51) Int. Cl. G06F 17/22

(52) U.S. Cl. CPC G06F 17/2235
USPC 715/208

(57) ABSTRACT

Problem links (for example, links to web pages) are replaced by replacement resources (for example, web pages). A process for determining a replacement resource includes a collecting step and an identifying step. In the collecting step, in response to a determination that a problem link condition exists within the source document, context information is collected for the source document. In the identifying step, at least a first replacement resource is identified based, at least in part, upon the context information. The identity of problem links, along with associated replacement resource(s), may be stored in a network accessible cache or repository.

### FIELD OF THE INVENTION

The present invention relates generally to the field of network communications using documents (for example, web pages) which documents include links to network resources (for example, web pages, files available on network servers, etc.).

### BACKGROUND OF THE INVENTION

While searching the internet for solutions to technical problems, it is not uncommon to encounter old content indexed by a search engine that provides a seemingly useful link to: (i) a web page (sometimes herein simply referred to as “page”) that no longer exists (herein called a “broken link”); or (ii) a page that has changed in content so that it is no longer useful to a typical user who clicks on the link (herein called an “obsolete link”). Broken and/or obsolete links may occur: (i) in the links listed in search engine results; (ii) on any page that the search engine identifies; (iii) on web pages that a user finds by “web surfing” or any other way that users find web pages; and/or (iv) on computer-based documents other than web pages such as word processing documents, slide show documents, etc. No matter where they happen to occur, broken and/or obsolete links are usually regarded as a problem, a waste of time for the user. Broken and/or obsolete links may link (or have been originally intended to link) to network resources other than web pages, such as graphic files, audio files, etc.

It is known that web pages include metadata, such as: (i) what language the web page is written in; (ii) what tools were used to create the web page; and (iii) where to go for more on the subject of the web page.

### SUMMARY

Various embodiments of the present invention disclose a computer-implemented method, a computer program product, and a computer system. These embodiments are and/or implement a process that includes a collecting step and an identifying step. In the collecting step, in response to a determination that a problem link condition exists within the source document, context information is collected for the source document. In the identifying step, at least a first replacement resource is identified based, at least in part, upon the context information.

### BRIEF DESCRIPTION OF THE SEVERAL VIEWS OF THE DRAWINGS

FIG. 1 is a schematic view of a first embodiment of a computer system (that is, a system including one or more processing devices) according to the present invention;

FIG. 2 is a schematic view of a computer sub-system (that is, a part of the computer system that itself includes a processing device) portion of the first embodiment computer system;

FIG. 3 is a flowchart showing a process performed, at least in part, by the first embodiment computer system;

FIG. 4 is a schematic view of a portion of the first embodiment computer system;

FIG. 5A is a first screenshot generated by the first embodiment computer system;

FIG. 5B is a second screenshot generated by the first embodiment computer system; and

FIG. 6 is a flowchart showing a process according to an embodiment of the present invention.

### DETAILED DESCRIPTION

This DETAILED DESCRIPTION section will be divided into the following sub-sections: (i) The Hardware and Software Environment; (ii) Operation of Embodiment(s) of the Present Invention; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

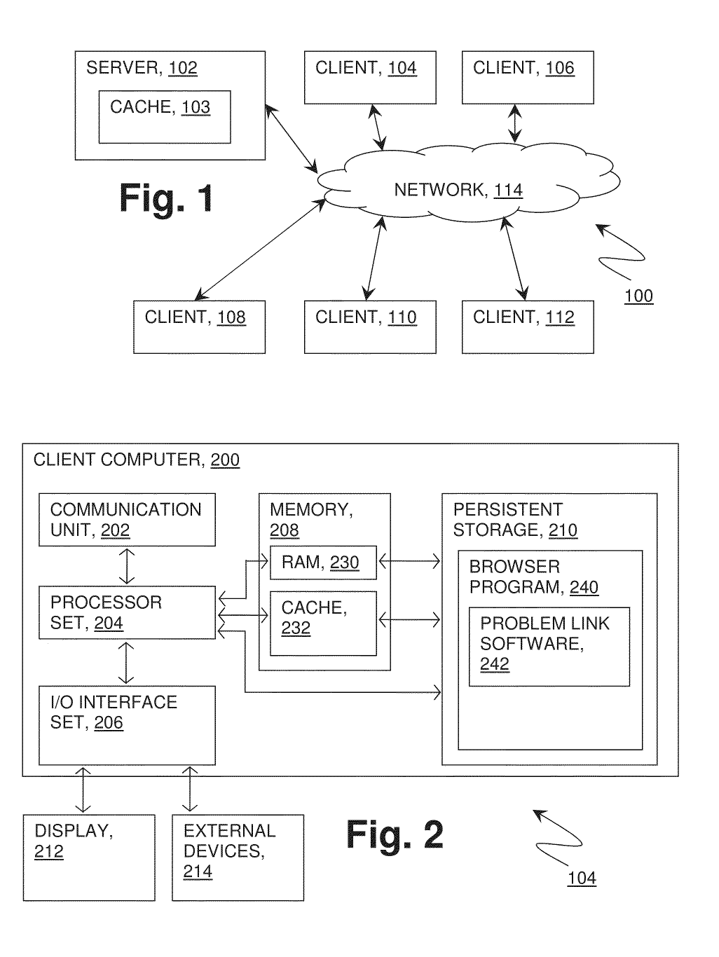

An embodiment of a possible hardware and software environment for software and/or methods according to the present invention will now be described in detail with reference to the Figures. FIGS. 1 and 2 collectively make up a functional block diagram illustrating various portions of distributed data processing system 100, including: server computer sub-system (that is a portion of the larger computer system that itself includes a computer) 102; problem link replacement resource(s) cache 103, client computer sub-systems 104, 106, 108, 110, 112; communication network 114; client computer 200; communication unit 202; processor set 204; input/output (i/o) unit 206; memory device 208; persistent storage device 210; display device 212; external device set 214; random access memory (RAM) devices 230; cache memory device 232; browser program 240; and problem link software 242.

As shown in FIG. 2, client computer sub-system 104 is, in many respects, representative of the various computer sub-system(s) in the present invention. Accordingly, several portions of computer sub-system 104 will now be discussed in the following paragraphs.

Client computer sub-system 104 may be a laptop computer, tablet computer, netbook computer, personal computer (PC), a desktop computer, a personal digital assistant (PDA), a smart phone, or any programmable electronic device capable of communicating with the client sub-systems via network 114. Browser program 240 is a representative piece of software, and is a collection of machine readable instructions and data that is used to create, manage and control certain software functions that will be discussed in detail, below, in the Operation of the Embodiment(s) sub-section of this DETAILED DESCRIPTION section.

Client computer sub-system 104 is capable of communicating with other computer sub-systems via network 114 (see FIG. 1). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1 and 2, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 2, client computer sub-system 104 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 104; and/or (ii) devices external to sub-system 104 may be able to provide memory for sub-system 104.

Program 240 is in many respects representative of the various software modules of the present invention and is stored in persistent storage 210 for access and/or execution by one or more of the respective computer processors 204, usually through one or more memories of memory 208. Persistent storage 210 is at least more persistent than a signal in transit is, but the persistent storage may, of course, be substantially less persistent than permanent storage. Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 104, such as client sub-systems 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with client computer 200. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Operation of Embodiment(s) of the Present Invention

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

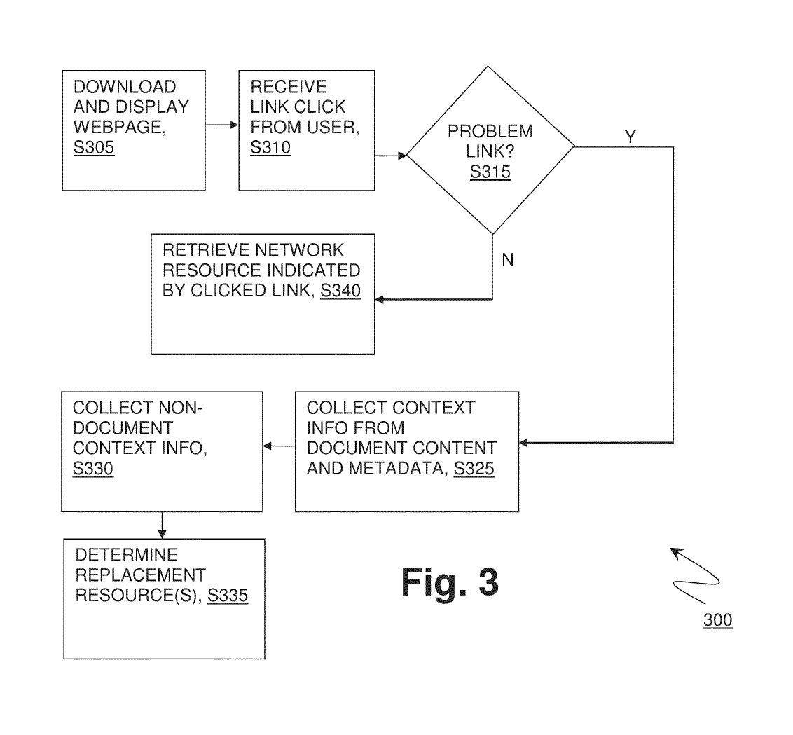

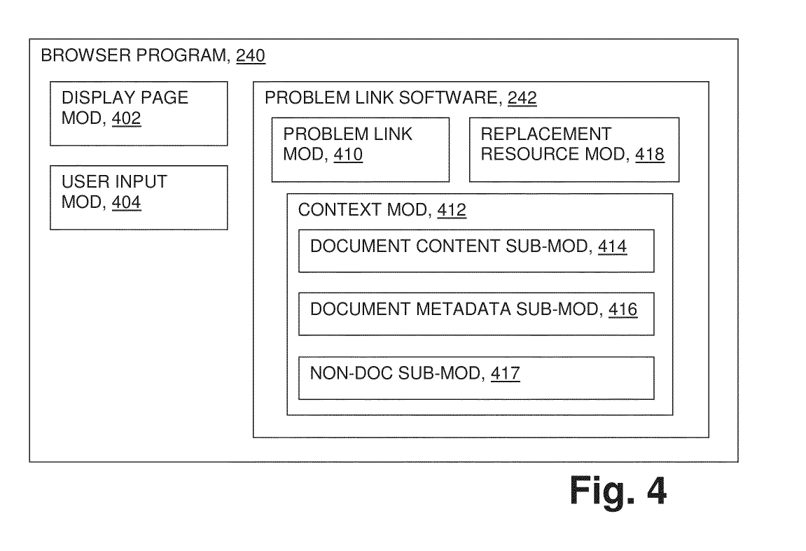

FIG. 3 shows process 300 according to the present invention. The steps of process 300, as shown by the flowchart of FIG. 3, are performed by browser program 240, as shown in FIG. 4. The following paragraphs will discuss this embodiment of the present invention with extensive reference to FIGS. 3 and 4.

Processing begins at step S305 where display page mod 402 of browser program 240 downloads and displays a “source document” in the form of a web page from the internet (see FIG. 1 at network 114). A “source document” is any document that includes a link to a network resource. While the source document in this example is a webpage, the source document could take other forms, such as a locally stored word processing file that contains a hyperlink.

Processing proceeds to step S310 where a user clicks the link in the source document (that is, in the webpage), and this user input is received by user input mod 404 of browser program 240 through a mouse input device (see FIG. 2 at reference numeral 214). Alternatively, other types of user input could be received that indicates that the user wants to view the linked material (for example, voice commands by the user). As a further alternative, the “user” may be software, such as a program designed to automatically print out a web page and all the material(s) linked in the source web page.

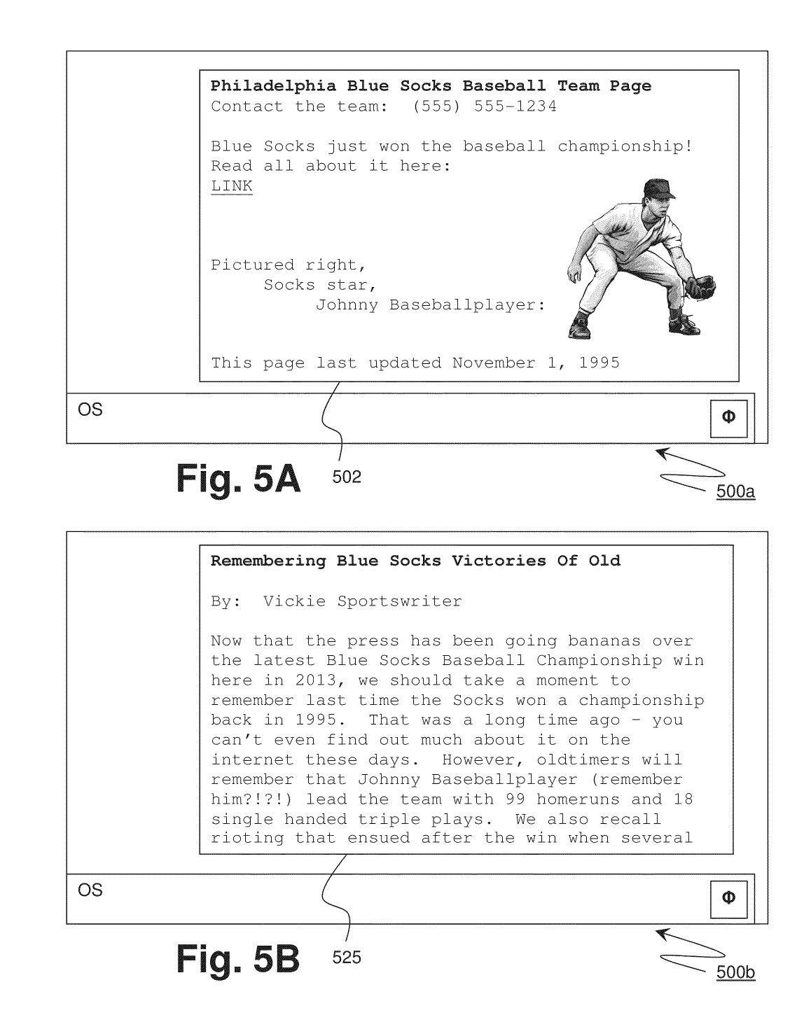

An example of step S310 is shown in web page 502 of display 500a of FIG. 5A. More specifically, in this source web page relating to a baseball team, the link occurs at the underlined and all CAPS occurrence of the word “link.” The website indicates that the linked network resource is intended to be an article about the baseball team winning a championship. Because the source web page indicates that the source web page was last updated on Nov. 1, 1995, it is likely that the article, which is intended to be linked, is at least as old as that Nov. 1, 1995 date.

Processing proceeds to step S315, where problem link mod 410 of problem link software 242 of browser program 240 determines whether the link is a “problem link.” A problem link is any type of link that is considered problematic by the system designer such that replacement resource(s) should be offered and/or automatically provided by the system. The preconditions that will cause a link to be considered as a problem link will vary from system to system. In various embodiments of the present invention, problem link precondition(s) may include one or more of the following precondition(s): (i) broken link; (ii) irrelevant link; (iii) linked material includes material not suitable for children or otherwise unsuitable (also called, filtered link); (iv) linked material requires payment or password (also called, restricted link); and/or (v) linked material is suspected of including malware, computer virus, etc. (also called, suspect link).

The determination of whether a link is a problem link is generally made automatically by the software without input from the user. This determination of the existence or non-existence of problem link preconditions may be made using one or more of the following techniques: (i) the linked network resource is fully downloaded “in the background” (out of sight of the user) and is reviewed for problem link preconditions; (ii) the linked network resource is downloaded in a quarantined (for example, downloaded on a temporary virtual machine within the client computer) or partial manner and is reviewed for problem link preconditions without being fully and normally downloaded; (iii) problem link replacement resource(s) cache 103 of server computer sub-system 102 (see FIG. 1) is consulted to determine if the link is on a pre-existing list of problem links; and/or (iv) other pre-existing software (not shown in the Figures, for example, anti-virus software) indicates that the link is a problem link.

If step S315 determines that the link is not a problem link, then processing proceeds to step S340 where display page mod 402 of browser software 240 downloads the linked network resource (if it has not been previously downloaded at step S315) and displays it to the user.

On the other hand, if step S315 determines that the link is a problem link, then processing proceeds to step S325 where: (i) document content sub-mod 414 of context mod 412 determines relevant context information (if any) from content of the source document; and (ii) document metadata sub-mod 416 of context mod 412 determines relevant context information (if any) from the metadata of the source document.

As an example of determining relevant context information based upon document content (that is, substantive content), as shown in display 500a of FIG. 5A, the substantive content of source web page 502 includes the following information: (i) “Philadelphia Blue Socks;” (ii) “championship;” (iii) “Johnny Baseballplayer;” and (iv) “last updated Nov. 1, 1995.” This is all context information that is potentially helpful in automatically finding replacement resource(s) for the problem link in source web page 502. In some embodiments, the textual proximity of each piece of substantive-content context information to the problem link itself may also be detected, because this may help provide relative weights to various items of context when finding replacement resource(s) (as will be discussed below).

As an example of determining relevant context information based upon document metadata, web page 502 will have various metadata (not shown) including: (i) creation date; (ii) last edit date; (iii) party owning the URL of the source web page; (iv) what language the web page is written in; (v) what tools were used to create the web page; and/or (vi) where to go for more on the subject of the web page. In this example, the “last edit date” metadata is likely to be especially helpful context information when trying to find germane, relevant and helpful replacement resource(s). The last edit date may be especially helpful context information because, if there are multiple past versions of the web page corresponding to the problem link stored in a cache, then the “last edit date” can help determine which version(s) of the web page might constitute the best replacement resource(s). It is noted that the metadata being discussed in this paragraph is metadata of the source document and not metadata associated with a web page of the problem link (or a web page that used to be associated with the problem link at one time in the past). Any web page metadata of a web page that is (or was) identified by the problem link is not considered as “context information” as that term is defined herein. For example, the URL (uniform resource locator) which is the problem link is not “context information,” but, rather “problem link information.” It is currently conventional to use (at least certain kinds of) problem link information in determining replacement resource(s), but this is not to be confused with the use of context information in accordance with some embodiments of the present invention.

Processing proceeds to step S330 where non-document sub-mod 417 of context mod 412 determines relevant context information (if any) from information not present in the source document. Non-document context information may include one or more of the following: (i) date and time that the user clicks the problem link; and (ii) geographical location of the user who clicks the problem link.

Processing proceeds to step S335 where replacement resource mod 418 determines one or more replacement resource(s) based upon the context information collected by context mod 412. The replacement resource(s) may be found from in and among one or more of the following: (i) special purpose cache for problem links (see FIG. 1 at reference numeral 103); (ii) a general purpose cache of archived network resources (for example, the Wayback Machine and its associated Internet Archive); (iii) the search-engine-searchable part of the internet; (iv) private networked databases; and/or (v) other non-networked databases. The best replacement resource(s) are determined based, at least in part, on the context information developed above at steps S325 and S330.

An example of step S335 is shown in web page 525 of display 500b of FIG. 5B. The replacement resource shown does not clearly correspond to the same news article originally linked within the source web page because the text discusses a championship in 2013, while the source web page was last updated many years previous in 1995. This is because replacement resource mod 418 has automatically determined that the specified link is a problem link and has automatically identified and presented a replacement resource using a web search including context information identified by context module 412 based on the source web page, and perhaps also non-document context information. The context information that may have been used includes: (i) “Philadelphia Blue Socks;” (ii) “championship;” (iii) “Johnny Baseballplayer;” and/or (iv) “last updated Nov. 1, 1995.”

In some embodiments of the present invention, context module 412 detects textual proximity not only by the number of words between a piece of context information and the problem link, but also by the physical distance, such as the number of pixels, from the problem link as presented on the webpage. For example, in FIG. 5A, the text “Blue Socks” is closer in physical distance than the text “Johnny Baseballplayer.” In some embodiments, the physically closer text is given a higher relative weight than the more distant text. In other embodiments, textual proximity is based on a combined weight of the two distances. In that case, the relative weight assigned to the term “blue socks” based on physical distance may be offset by the number of words from the problem link.

### III. Further Comments and/or Embodiments

Some embodiments of the present invention provide a system/method for substituting requested web content which is no longer available and/or relevant with contextually-relevant cached copies of such content. Some embodiments of the present invention may replace broken links with links to newer and/or identical web resources, but only works well in situations where those resources exist. Other, perhaps more preferred, embodiments would provide a replacement resource to the user without the need to have a copy of it currently available on the web.

There are publicly available “web archives” that take periodic snapshots of content on the web and allows the user to choose a date to “go back” to what that page looked like on that date (for example, http://wayback.archive.org). In one embodiment of the present invention, a similar, but augmented, web caching system would be used. The augmented web caching system of this embodiment provides cached copies of “replacement resources” by: (i) date/time; (ii) geographical location; and (iii) other factors.

Some embodiments of the present invention provide a system, and associated method, that: (i) identifies broken and/or irrelevant links during a user's web browsing session; and (ii) intelligently identifies the “context” of the broken link (for example, the date/time it was posted and the geographical location of the user, among other factors). Once this context is determined, a public or private web cache/archival system, in this embodiment, provides the relevant content (sometimes herein referred to as “replacement content” or “replacement resource(s)”) to the user.

Some embodiments of the present invention may have one or more of the following possible advantages: (i) efficient, automatic process for determining replacement content process; and/or (ii) use of context in determining more relevant, or otherwise better, replacement resource(s).

Some embodiments of the present invention automate the process of identifying broken or irrelevant links, and presenting the most contextually-relevant content to the user (considering factors like desired date/time of snapshot, geographical location of the user, etc), via an advanced web caching system. Some embodiments of this invention involve a web browser (or plug-in) that automates this process for the user based on user settings, etc.

In one embodiment of the present invention, a user searches a popular internet search engine for solutions to a problem. This internet search leads to a web page that includes a forum post that seems to pertain to the user's problem. Encouragingly, this forum post on the web page document mentions a solution and provides a link to the solution. Less encouragingly, the link is broken (not found or a server error, etc.). Fortunately, this embodiment of the present invention: (i) recognizes the broken link as being broken; and (ii) queries a web caching system for this URL/page at the closest available date/time to the date/time of the forum post. The cached page, based on the date/time, is presented to the user, in place of the broken link/“404 page.” At least some embodiments of the present invention that include this kind of “problem link replacement cache” will also have the context-related features discussed at length above, especially in the Operation Of Embodiment(s) sub-section, above, in this DETAILED DESCRIPTION section.

There are at least two types of problem link replacement caches: (i) a cache that is specifically created and designed to function as a dedicated problem link replacement cache; and (ii) a pre-existing cache (for example, the Internet Wayback Machine, mentioned above) that was not originally designed as a problem link replacement cache, but is used for that purpose in accordance with some embodiments of the present invention.

In another embodiment of the present invention, a user again searches a popular search engine for solutions to a problem. One of the links on the results page seems to provide a solution, but the content on the linked-to page is now vastly different from the original cached page that the search engine has indexed. This could be identified in several different ways including the following: (i) through a content analysis on the source page/content page; (ii) through occasional web cache lookups/comparisons; and/or (iii) through user feedback/tagging (for example, “this page is not what I wanted”). In this embodiment, the system queries the web caching system with the relevant context (appropriate date/time and geographical location of the user). The cached page, based on the supplied context, is presented to the user in place of the “newer”/irrelevant content.

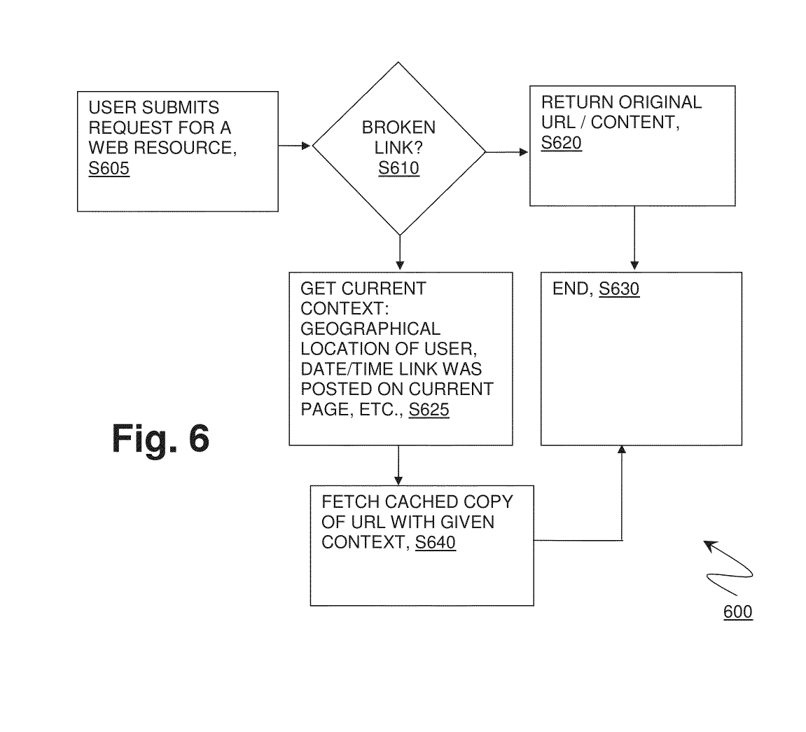

FIG. 6 shows process 600 according to an embodiment of the present invention and includes the following steps: S605; S610; S620; S625; S630; and S640. Process flow among and between these steps is as shown in FIG. 6. Note that the process embodiment of FIG. 6 involves calling on a problem link replacement cache at step S640. By caching web pages (or other network resources) in such a cache, the replacement resource can be made to very closely match the originally linked network resource (that is, the resource the creator of the web page wanted readers to experience), even in cases where the originally linked resource is effectively gone from the publically-accessible portion of the internet.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as may be being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: non-exclusive or; for example, A and/or B means that: (i) A is true and B is false; or (ii) A is false and B is true; or (iii) A and B are both true.

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a non-transient manner in one or more tangible storage medium(s); “software storage device” does not include any device that stores computer code only as a signal.

What is claimed is:

1. A computer implemented method comprising:
in response to a determination that a problem link condition exists within a source document, collecting context information for the source document; and
identifying at least a first replacement resource, based, at least in part, upon the context information.

2. The method of claim 1 wherein the problem link condition is one of the following: a broken link, an irrelevant link, a restricted link, a filtered link, and a suspect link.

3. The method of claim 1 wherein the context information includes at least information from one of the following: content of the source document, and metadata of the source document.

4. The method of claim 3 wherein the context information includes last edit date from the metadata of the source document.

5. The method of claim 3 wherein:
the context information from the content of the source document includes: a piece of substantive-content context information and textual proximity information about textual proximity between the piece of substantive-content context information and the problem link.

6. The method of claim 1 wherein the context information includes at least information extraneous to the source document.

7. A computer program product comprising a computer readable storage medium including a computer readable program, wherein the computer readable program when executed by a processor on a computer causes the computer to:
in response to a determination that a problem link condition exists within a source document, collect context information for the source document; and
identify at least a first replacement resource, based, at least in part, upon the context information;

8. The computer program product of claim 7 wherein the problem link condition is one of the following: a broken link, an irrelevant link, a restricted link, a filtered link, and a suspect link.

9. The computer program product of claim 7 wherein the context information includes at least information from one of the following: content of the source document, and metadata of the source document.

10. The computer program product of claim 9 wherein the context information includes last edit date from the metadata of the source document.

11. The computer program product of claim 9 wherein:
the context information from the content of the source document includes: a piece of substantive-content context information and textual proximity information about textual proximity between the piece of substantive-content context information and the problem link.

12. The computer program product of claim 7 wherein the context information includes at least information extraneous to the source document.

13. A computer system comprising:
a processor(s) set; and
a software storage device;
wherein:
the processor set is structured, located, connected and/or programmed to run software stored on the software storage device; and
the software comprises:
first program instructions programmed to, in response to a determination that a problem link condition exists within a source document, collect context information for the source document; and
second program instructions programmed to identify at least a first replacement resource, based, at least in part, upon the context information.

14. The computer system of claim 13 wherein the problem link condition is one of the following: a broken link, an irrelevant link, a restricted link, a filtered link, and a suspect link.

15. The computer system of claim 13 wherein the context information includes at least information from one of the following: content of the source document, and metadata of the source document.

16. The computer system of claim 15 wherein context information includes last edit date from the metadata of the source document.

17. The computer system of claim 15 wherein:
the context information from the content of the source document includes: a piece of substantive-content context information and textual proximity information about textual proximity between the piece of substantive-content context information and the problem link.

18. The computer system of claim 13 wherein the context information includes at least information extraneous to the source document.
